(19) United States
(12) Patent Application Publication
(10) Pub. No.: US 2010/0089124 A1
(43) Pub. Date: Apr. 15, 2010

(54) INTEGRATED POROUS RIGID WALL AND FLEXIBLE WALL PERMEABILITY TEST DEVICE FOR SOILS

(75) Inventors: DINESH RAMANATH KATTI, Fargo, ND (US); PRIYANTHI AMARASINGHE, ELKRIDGE, MD (US); KALPANA S. KATTI, Fargo, ND (US)

Correspondence Address: MCKEE, VOORHEES & SEASE, P.L.C., 801 GRAND AVENUE, SUITE 3200, DES MOINES, IA, 50309-2721, US

(73) Assignee: NORTH DAKOTA STATE UNIVERSITY, Fargo, ND (US)

(21) Appl. No.: 12/567,343

(22) Filed: Sep. 25, 2009

Related U.S. Application Data
(60) Provisional application No. 61/100,550, filed on Sep. 26, 2008.

(51) Int. Cl. G01N 15/08

(52) U.S. Cl. 73/38

(57) ABSTRACT

An apparatus for measuring permeability accurately in expansive clay and non-expansive soils is provided. The apparatus includes hollow porous stone cylinders which prevent the sample from bulging and at the same time allow application of confining pressure on the soil sample enclosed in a flexible membrane, which simulates the field condition and allows for application of back pressure to aid in saturation. The apparatus also allows for accurate comparison of hydraulic characteristics of swelling clays with fluids of various dielectric and other properties. The apparatus can also be used to consolidate the sample either three dimensionally or in one direction and perform permeability tests as well as find out the consolidation characteristics of the sample.

### RELATED APPLICATIONS

This application claims priority under 35 U.S.C. §120 to U.S. Patent Application No. 61/100,550 filed Sep. 26, 2008, which application is hereby incorporated by reference in its entirety.

### GRANT REFERENCE

This invention was made with government support under Grant No. 0556020 awarded by the National Science Foundation. The government has certain rights in the invention.

### FIELD OF THE INVENTION

The present invention relates generally to an apparatus for measuring soil permeabilities. More particularly, the present invention provides an apparatus for accurately measuring permeability in expansive and non-expansive soils while simulating actual field conditions.

### BACKGROUND

The coefficient of permeability is an important parameter for soils that helps with predicting fluid flow characteristics of soils quantitatively. The ability to predict fluid flow in soils is very important for design of clay liners for landfills, predicting flow of contaminants through soils, ground water flow and wells, dams, flood control embankments, etc. Typically, permeability tests are conducted on soil samples to evaluate the coefficient of permeability. As much as possible, the soil samples are subject to stress conditions in the field and are compacted to density in the field. Whenever possible, “in-situ” undisturbed cores of the soil from the field are used to conduct the permeability test in the case of soils that are sensitive to changes in microstructure.

Rigid wall and flexible wall are the two main types of permeameters that are being used in measuring permeability of soils. Although, rigid wall permeameters are acceptable for measuring permeability in sand and coarse grained soils which have a high hydraulic conductivity, rigid wall permeameters are not recommended for measuring permeability of clayey soils or soils which have low hydraulic conductivity. Rigid wall permeameters have several disadvantages, including but not limited to the inability to apply any lateral confining pressure to the sample, potential leakage along the interface between the wall and the sample and difficulty in preparation of field samples to fit exactly in the rigid wall cylinder without any disturbance to the sample. The flexible membrane in the flexible wall permeameters provides the flexibility in the wall to make better contact between the sample and the wall so there will be no gap in the interface thus, no side wall leakage. In addition, flexible wall permeameters allow application of confining pressure to simulate field stress conditions.

The issues with flexible wall permeameters are far more complicated when one has to deal with expansive clays and especially with highly expansive clays like bentonite which is one of the main constituents of Geosynthetic Clay Liners (GCL). One of the major problems with existing flexible wall permeameters is the inability to provide reliable and relevant test results, especially when testing extremely high swelling clays, which when contacted with water causes bulging of the sample in flexible wall permeability test device which in-turn alters the cross-sectional area and microstructure of the sample. These problems are accentuated in the case where the clay is dry and the sample has a high void ratio. Numerous researchers have studied the swelling pressure of expansive clays like bentonite experimentally [1-6] and theoretically [7-13] and have seen swelling pressures ranging from 95 kPa to 575 kPa. It also has been seen that reducing the clay swelling in one direction tends to significantly increase the clay swelling in the other direction [14]. Since vertical swelling in the sample is stopped with a locking rod in present permeameters, the lateral swelling pressure could rise in excess of the swelling pressures previously noted. To attempt to resolve this problem, researchers use cathetometers to detect any volume change in the sample during the permeability test [15]. The use of cathetometers is a crude solution to the problem. Standard procedures for conducting permeability suggest maintaining the effective confining pressure in the cell at about 1.5 times the swell pressure of sample [16]. Applying confining pressure to remove sample bulging or for applying very high confining pressure before the sample is saturated would cause significant disturbance to the sample leading to unreliable results. Furthermore, maintaining the effective confining pressure at 1.5 times the swelling pressure in expansive clay, especially dry clay with a high void ratio, remains highly questionable. That said, measuring permeability of this type of clay (with very low initial moisture content) is extremely important in landfill liner design since dry (or very low moisture content) bentonite is one of the main constituents in Geosynthetic Clay Liners (GCL). Another drawback of currently used flexible wall permeameters is the inability to allow the sample to swell or consolidate vertically without any lateral expansion, which simulates the removal or adding of overburden pressure, and perform the permeability test on the swelled or consolidated samples.

Therefore, a need has been identified in the art for an apparatus that allows accurate measuring of permeability, consolidation and swelling characteristics of non-expansive and expansive soils under field conditions, including at low initial moisture content.

Consolidation characteristics of clays have been studied by number of researchers and it has been observed that the mineralogy is a factor in variation of coefficient of consolidation “Cᵥ” [18]. However, no literature is available on the study of effect of fluid properties such as dielectric constant on the compressibility of samples, such as, Na-montmorillonite, saturated with different solvents under no volume change condition which mimics most field conditions. The lack of information in this area is likely due at least in part to the difficulty in keeping the volume of the sample constant during the saturation process using currently available triaxial cells and the rapid degradation in currently available cell membranes such as Latex when used with most low polarity solvents, such as toluene.

Therefore, a need in the art has been identified for an apparatus that allows accurate measuring of permeability, consolidation and swelling characteristics of non-expansive and expansive soils under field conditions by keeping the sample volume constant and by using non-degradable membranes.

### BRIEF SUMMARY

All aspects of the present invention may be achieved by an apparatus for measuring soil permeability, consolidation and swelling characteristics in expansive or non-expansive soil samples. The apparatus includes an enclosure adapted to house soil for acquiring soil permeability, consolidation and swelling characteristics of the soil sample. The enclosure includes a rigid wall of a permeable material to assist in introducing pressure into the enclosure. In a preferred form, the apparatus includes a flexible membrane within the enclosure whereby pressure introduced into the enclosure acts on the flexible membrane to apply confining or constraining pressure on the sample. The permeable material may be a rigid porous material, such as a rigid porous stone ring or a rigid porous stone cylinder. To accommodate taller soil samples the apparatus may include multiple rigid porous stone rings or a taller rigid porous stone cylinder. The present invention contemplates that the shape of the rigid enclosure could be circular, square, rectangular, polygonal or any other cross-section. The rigid porous stone cylinders may include first and second halves to assist in releasing the soil sample from the enclosure. The enclosure may include separate top and bottom end caps having a recess to receive at least a portion of the rigid porous stone cylinder to assist in holding the enclosure together. The top and bottom end caps may include first and second halves to assist in releasing the soil sample from the enclosure.

According to another aspect of the present invention, an apparatus for measuring soil permeability, consolidation and swelling characteristics in an expansive or non-expansive soil sample is disclosed. The apparatus includes an enclosure adapted to house the soil sample for acquiring soil permeability, consolidation and swelling characteristics and a flexible membrane within the enclosure acted on by pressure introduced into the enclosure to apply confining or constraining pressure on the soil sample. The enclosure includes a rigid wall having a porous stone cylinder to assist in introducing pressure into the circular enclosure at the same time to prevent the sample from bulging.

### BRIEF DESCRIPTION OF THE DRAWINGS

FIGS. 1A-B show porous stone cylinders or rings according to an exemplary embodiment of the present invention.

FIGS. 2A-C show various views of the apparatus of the present invention.

FIG. 3 shows a schematic of the apparatus in a test cell according to an exemplary embodiment of the present invention.

FIGS. 4A-D are engineering drawings of the holding cap illustrated in a side elevation view (see FIG. 4A), a cross-sectioned view taken along line A-A in FIG. 4C (see FIG. 4B), a top view (see FIG. 4C), and a cross-sectional view taken along line B-B in FIG. 4E (see FIG. 4D).

FIGS. 5A-B show plots for the amount of water absorbed by the sample with increasing saturation time.

FIG. 6 is a plot illustrating the increase in the swelling pressure of the sample with increasing saturation time.

### DETAILED DESCRIPTION

The following description is merely exemplary in nature and is not intended to limit the present disclosure, application, or uses.

The apparatus 10 overcomes the problems with swelling clays by incorporating the constraining feature of a rigid wall and at the same time allow a confining pressure to be applied to the sample by passing through a “porous” rigid wall and acting on a flexible wall. The apparatus 10 of the present invention allows measuring permeability of expansive clay with no volume change in the sample during the time of the experiment and at the same time has all the advantages of a flexible wall permeameter that allows application of confining pressure, avoiding any leakage along the interface between the sample and the wall, application of back pressure for saturation, and verification of saturation. The apparatus 10 of the present invention is also useful for conducting tests on swelling soils where the fluid being used can alter swelling characteristics of the clay. The apparatus 10 also allows for conducting experiments to evaluate permeability of swelling soils for different magnitudes of swelling. At the same time apparatus 10 allows measuring the permeability of the sample at different consolidation levels. The sample can be consolidated vertically or both vertically and laterally at different consolidation levels making it is possible for measuring permeability of the sample at different consolidation levels. Also, split cylinders allow for easy removal of the experimented sample with minimal disturbance for further structural characterization studies using X ray analysis, IR spectroscopy, and/or scanning electron microscopy.

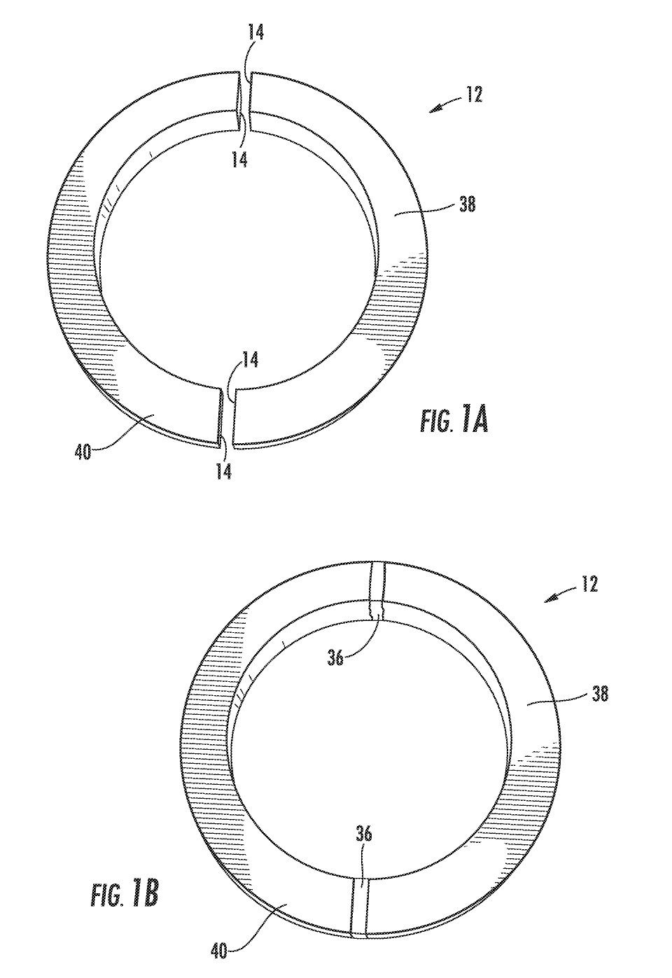

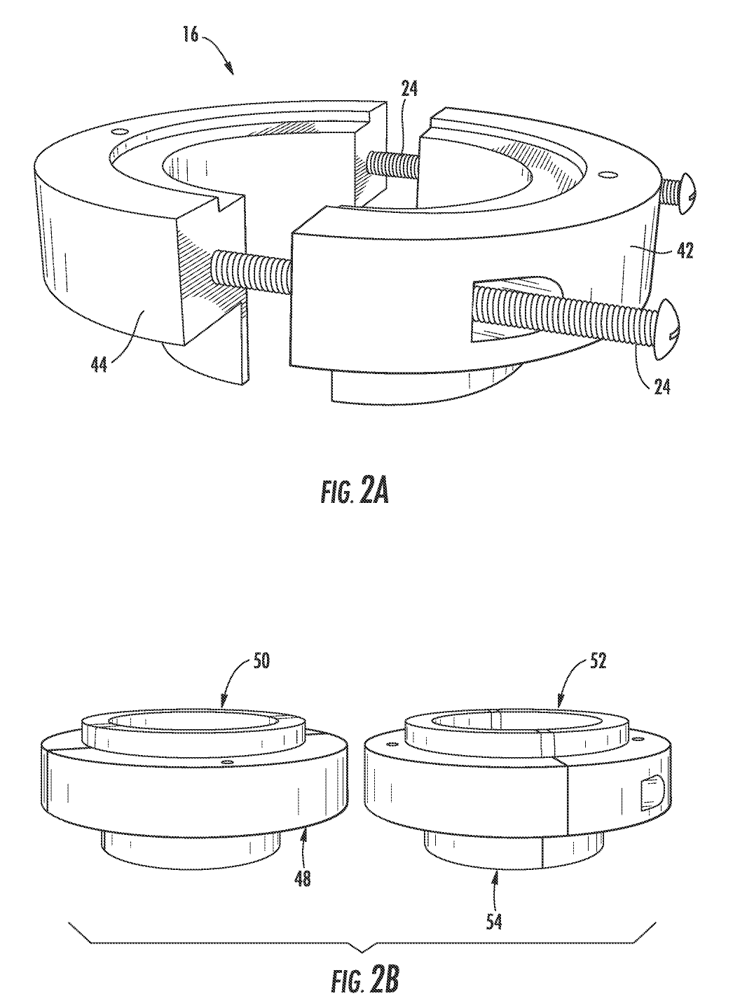

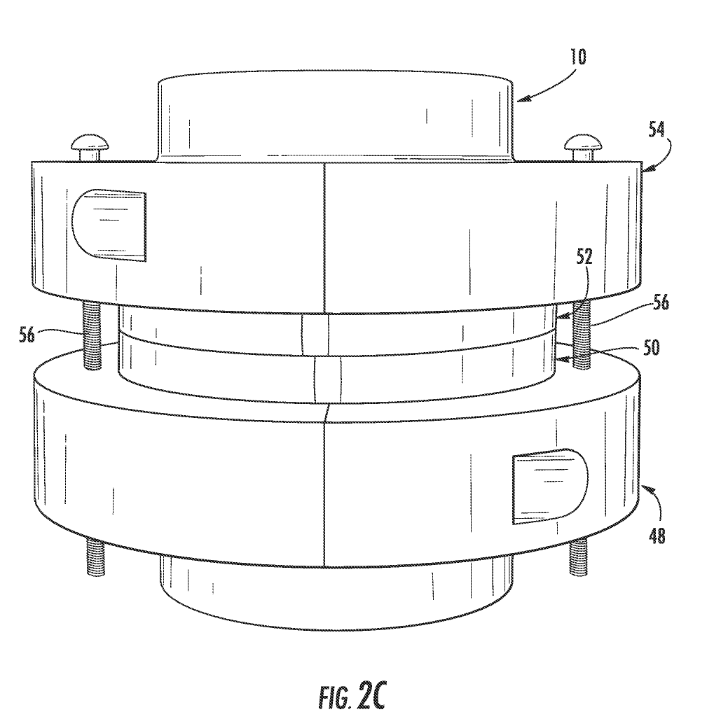

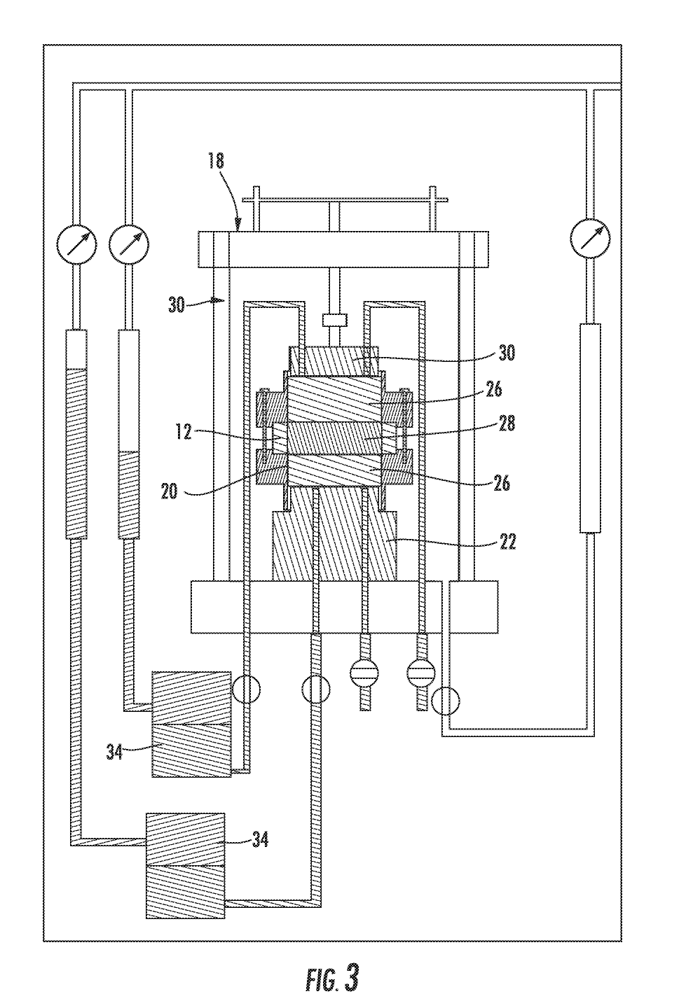

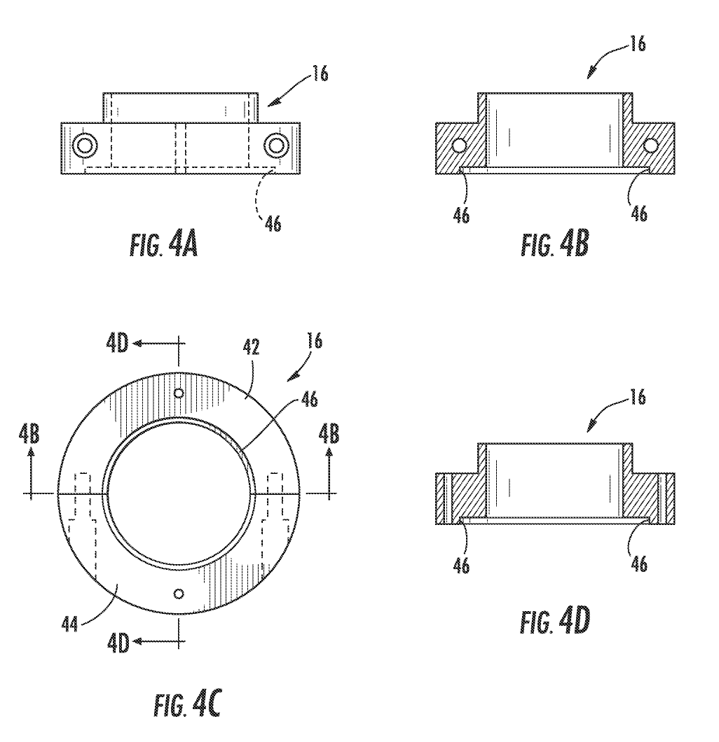

Components of apparatus 10 according to one aspect of the invention are shown in FIGS. 1 through 4D. Apparatus 10 includes porous cylinders/rings 12 cut with a desired diameter and split in two portions (first cylinder/ring portion 38 and second cylinder/ring portion 40) for easy assembling and dismantling (FIG. 1A). In one aspect of the invention, porous cylinder/rings 12 comprise porous stone cylinder/rings. The space between the two opposite ends 14 of the porous stone cylinders/rings 12 are filled with filler 36, such as, epoxy glue, to maintain the circular shape of the cylinders 12 and to minimize the friction at the two ends 14 of the half cylinders 12 as shown in FIG. 1B. End caps 16 (made up of a first end cap portion 42 and a second end cap portion 44) that hold the porous stone cylinders/rings 12 are shown in FIG. 2A-C, and the complete set-up of the apparatus 10 in a permeability cell 18 is shown in FIG. 3. Each end cap 16 includes a recess 46 (such as an annular recess) for receiving at least a portion of the porous stone cylinders/rings 12. The design of end caps 16 is shown in FIGS. 4A-D, illustrating top, side elevation and sectional views taken along lines A-A and B-B in FIG. 4C. The present invention contemplates that the porous stone cylinders/rings 12 may be fabricated from various types of materials other than stone, which have sufficient porosity to allow passage of liquid or air there through. Similarly, end caps 16 may be fabricated from any material resistive to rust or other similar forms of material degradation. In one aspect of the present invention, end caps 16 may be fabricated from stainless steel.

Apparatus 10 is fabricated and capable of testing expansive and non-expansive soils. Apparatus 10 is sufficiently robust for testing a highly swelling soil sample consisting of sodium montmorillonite clay. Tests confirm the ability of the apparatus 10 to also measure the permeability of swelling clay soils. Major steps in measuring permeability using apparatus 10 according to one aspect of the present invention are described herein.

One method for measuring permeability includes apparatus 10 being incorporated into a triaxial or permeability cell 18. A schematic illustration of an exemplary cell 18 is shown in the FIG. 3. A brief procedure in accordance with one aspect of the present invention now follows. A membrane 20, such as a Neoprene membrane, which is protected with Teflon adhesive tape is placed on the triaxial cell base 22 and two ‘O’ rings are placed to seal the membrane 20. The Neoprene membrane 20 may be obtained from Geotest Instrument Corporation, Evanston, Ill. The Neoprene membrane 20 is protected with Teflon adhesive tape and is the preferred replacement for the commonly used latex membrane, as the latex membrane is easily degraded by solvents, such as organic solvents, used in preparation of soil samples for testing permeability. If testing is conducted using fluids that do not degrade the membrane (e.g., water) than a latex membrane may be used. Next, a stainless steel end cap 16 (two halves 42 and 44), which may be functionally described as a lower porous stone holding cap 48, and the lower porous stone cylinder/ring 50 (two halves 38 and 40) are placed around the Neoprene membrane 20 as shown in the FIG. 3, and the two lateral screws 24 are tightened. Next, upper porous stone cylinder/ring 52 (two halves) is placed on the lower porous stone cylinder/ring 50 so that the complete porous stone cylinder 12 (four halves) is vertically aligned. A stainless steel cap 16 (two halves), which may be functionally described as an upper porous stone holding cap 54, is placed around the Neoprene membrane 20 and a portion of the upper porous stone cylinder/ring 52 (two halves). The two lateral screws 24 are tightened to secure the two halves of the upper porous stone holding cap 54 together. The lower 48 and upper 54 porous stone holding caps are secured by vertically oriented screws 56. Next, one or two porous stone discs 26 (the number of porous stone discs 26 used depends on the thickness of each stone disc) and a filter paper are placed on the cell base 22 inside the Neoprene membrane 20. A sample 28, such as dry Na-montmorillonite powder, is compacted inside the membrane 20 so that the height and the diameter of the sample 20 are 2.54 cm (1 inch) and 2.24 cm (2.85 inch) respectively, and the dry density of the sample 20 is about 850 kg/m3. Undisturbed samples obtained from the field such as soil cores having appropriate dimensions to fit in the device could also be placed in this device for testing. Lastly, the permeability cell top 30, two ‘O’ rings and the tri axial cell cover 32 are put in place followed by filling the cell with confining water, and flushing the air bubbles from the tubing in accordance with standard triaxial test procedures. In order to prevent organic solvents from coming in contact with the burette and annuls in the main panel, two interface chambers 34 are used as shown in the FIG. 3. The interface chambers 34, which consist of Viton membranes, may be obtained from Durham Geo Slope Indicator, Stone Mountain, Ga.

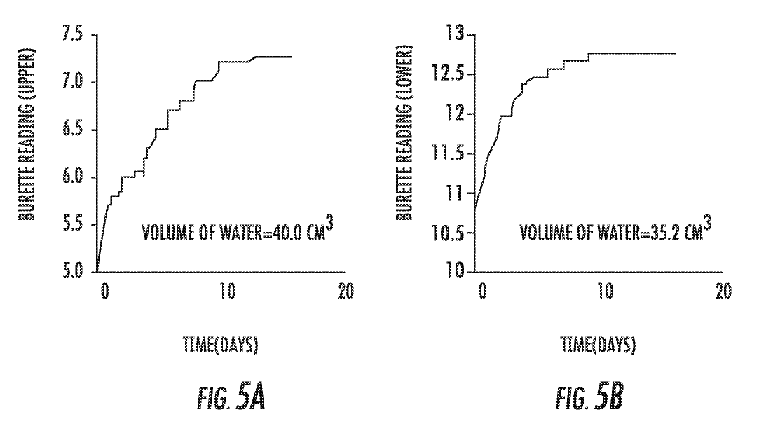

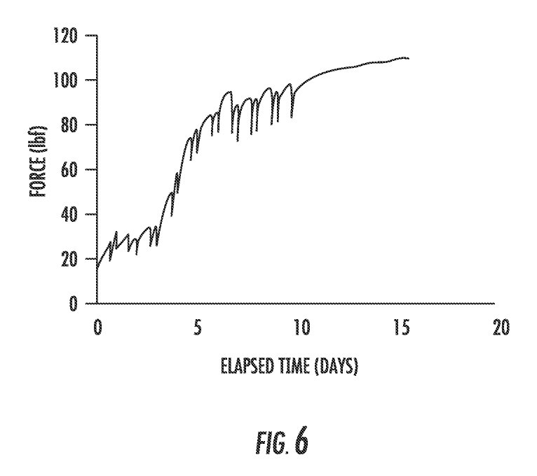

In one exemplary aspect of the present invention, Na-montmorillonite is compacted in the cell so that the unit weight of the sample is 849 kg/m³ and the height of the sample is 1 inch (2.5 cm). The sample is saturated increasing the back pressure up to 65 psi with small increments for about two weeks. Saturation is confirmed by checking the “B” value for 100%. Intake of water in the sample during saturation is measured and plotted against the time for the upper (see FIG. 5E) and lower (see FIG. 5B) burette reading. Each burette increment is 16 cm³. No significant absorption of water was observed after the 13^{th} day of saturation, which confirms full saturation of the sample. Swelling pressure of the sample was also measured during sample saturation and plotted against the increasing saturation time (see FIG. 6). Swelling force is dropped by 5-10 lbs in each back pressure increment. The rate of increase in the swelling pressure becomes insignificant after the 13^{th} day of saturation confirming full saturation of the sample.

The permeation stage is initiated by inducing a 4.5 psi pressure difference between the top and bottom of the sample. Data is collected after confirming the steady state flow condition through the sample. Permeability is calculated using the equation (1) in falling head, increasing tail water pressure method [16]. Data and the calculated permeability values for three different trials are presented in the Table 1.

TABLE 1

| Test | Δt | h₁ cm of | h₂ cm of | | | L | |
|---|---|---|---|---|---|---|---|
| No. | (sec) | water | water | a cm² | A cm² | cm | k cm²/sec |
| 1 | 345465 | 318.99 | 317.98 | 0.906 | 41 | 2.5 | 2.57E−10 |
| 2 | 345900 | 317.98 | 316.865 | 0.906 | 41 | 2.5 | 2.77E−10 |
| 3 | 346500 | 316.865 | 316.865 | 0.906 | 41 | 2.5 | 2.53E−10 |

According to test results, the average permeability of Na-montmorillonite is 2.62×10⁻¹⁰ cm/sec. This value is close to the permeability of past test results for this type of clay [17].

$$k = \frac{a \cdot L}{2 \cdot A \cdot Δ t} ln ( \frac{{h}_{1}}{{h}_{2}} ) \qquad ( 1 )$$

h₁=head loss across the sample at the beginning of the test

h₂=head loss across the sample at the end of the test

a=cross sectional area of the burette in cm²

A=cross sectional area of the sample in cm²

Δt=duration of the test in seconds

L=length of the sample in cm.

Apparatus 10 overcomes the problems associated with measuring permeability in swelling clays by using a constraining feature provided by a rigid wall and at the same time allow confining pressure to be applied to the sample through hollow porous stone cylinders 12 to the flexible wall membrane 20. Two hollow porous stone cylinders/rings 12 are cut from porous stone disks and stainless steel porous stone holders 16 are designed and fabricated as part of apparatus 10. Apparatus 10 can be used in accurately measuring permeability of swelling clays as well as any other non-expansive soils. Another important feature of apparatus 10 is the ability to consolidate the sample either three dimensionally or in one direction and perform permeability tests as well as find out the consolidation characteristics of the clay or other sample. Apparatus 10 also can be used in measuring permeability of clay or other samples at different percentages of swelling by allowing the sample to swell vertically.

The embodiments of the present invention have been set forth in the drawings and specification and although specific terms are employed, these are used in the generically descriptive sense only and are not used for the purposes of limitation. Changes in the formed proportion of parts as well as in the substitution of equivalence are contemplated as circumstances may suggest or are rendered expedient without departing from the spirit and scope of the invention as further defined in the following claims.

### REFERENCES

All references listed throughout the Specification, including the references listed below, are herein incorporated by reference in their entireties.
[1] Arto Muurinen, Ola Karnland, Jarmo Lehikoinen, Ion concentration caused by an external solution into the porewater of compacted bentonite, Physics and Chemistry of the Earth 29 (2004) 119-127.
[2] M. Victoria Villar, Antonio Lloret, Influence of dry density and water content on the swelling of a compacted bentonite, Applied Clay Science 39 (2008) 38-49.
[3] Shahid Azam and Sahel N. Abduljauwad, Influence of Gypsification on Engineering Behavior of Expansive Clay, Journal of Geotechnical and Geoenvironmental Engineering, 126, 6, (2000) 538-542.
[4] R. Pusch, P. Bluemling, L. Johnson, Performance of strongly compressed MX-80 pellets under repository-like conditions, Applied Clay Science 23 (2003) 239-244.
[5] R. Kaczyiiski, B. Grabowska-Olszewska, Soil mechanics of the potentially expansive clays in Poland, Applied Clay Science 11 (1997) 337-355.
[6] Sudhakar M. Rao and T. Thyagaraj, Swell-compression behaviour of compacted clays under chemical gradients, Can. Geotech. J. 44 (2007) 520-532.
[7] Y. F. Xu, H. Matsuoka, D. A. Sun, Swelling characteristics of fractal-textured bentonite and its mixtures, Applied Clay Science 22 (2003) 197-209.
[8] R. K. Taylor and T. J. Smith, The Engineering geology of Clay Minerals: Swelling, Shrinking and Mudrock Breakdown, Clay Minerals 21 (1986) 235-260.
[9] J. J. Spitzer, Electrostatic Calculations on Swelling Pressures of Clay-Water Dispersions, Langmuir 5 (1989)199-205.
[10] David E. Smith, Yu Wang, Heather D. Whitley, Molecular simulations of hydration and swelling in clay minerals, Fluid Phase Equilibria 222-223 (2004) 189-194.
[11] N. V. Nayak and R. W. Christensen, Swelling Characteristics of Compacted, Expansive Soils, Clays and Clay Minerals 19 (1971) 251-261.
[12] Snehasis Tripathy, Asuri Sridharan, and Tom Schanz, Swelling pressures of compacted bentonites from diffuse double layer theory, Can. Geotech. J. 41 (2004) 437-450.
[13] Mielenz, R. C. and King, M. E., Physical Chemical Properties and Engineering Performance of Clay, Proceeding of 1^{St} National Conference on Clays and Clay Minerals, Berkeley, Calif., California Division of Mines and Geology Bulletin 169 (1952) 196-264.
[14] Windal, T. and Shahrour, I., Study of the Swelling Behavior of a Compacted Soil Using Flexible Odometer, Mechanics Research Communications 29 (2002) 375-382.
[15] Daniel, D. E., Trantwein, S. I., Boyanton, S. S., and Foreman, D. E., Permeability testing with flexible wall permeameters, Geotechnical Testing Journal, GTJODJ, 7, 3, (1984) 113-122.
[16] American Society for Testing and Materials (ASTM) D5084, Standard Test Methods for Measurement of Hydraulic Conductivity of Saturated Porous Materials Using a Flexible Wall Permeameter.
[17] Hideo Komine, Simplified evaluation on hydraulic conductivities of sand bentonite mixture backfill, Applied Clay Science 26 (2004) 13-19.
[18] Di Maio, C., Santoli, L., and Schiavone, Volume change behavior of clays: the influence of mineral composition, pore fluid composition and stress state, Mechanics of Materials, 36(5-6), (2004) 435-451.

What is claimed is:

1. An apparatus for measuring soil permeability, consolidation and swelling characteristics in expansive or non-expansive soil samples comprising:
a. an enclosure adapted to house soil for acquiring soil permeability results of the soil sample; and
b. the enclosure having a rigid wall comprising a permeable material to assist in introducing pressure into the enclosure.

2. The apparatus of claim 1 further comprising a flexible membrane within the enclosure whereby pressure introduced into the enclosure acts on the flexible membrane to apply confining or constraining pressure on the sample.

3. The apparatus of claim 1 wherein the permeable material comprises a rigid porous material.

4. The apparatus of claim 3 wherein the permeable material is:
a. a rigid porous stone cylinder;
b. a rigid porous stone rectangular column;
c. a rigid porous stone square column; or
d. a rigid porous stone of another cross-section.

5. The apparatus of claim 1 wherein the rigid wall is:
a. multiple rigid porous stone cylinders to accommodate taller soil samples; or
b. a taller rigid porous stone cylinder to assist in accommodating taller soil samples.

6. The apparatus of claim 4 wherein the rigid porous stone cylinders comprises a split cylinder having first and second halves to assist in releasing the soil sample from the enclosure.

7. The apparatus of claim 4 wherein the enclosure further comprises separate top and bottom end caps having a recess to receive at least a portion of the rigid porous stone cylinder to assist in holding the enclosure together.

8. The apparatus of claim 7 wherein the top and bottom end caps comprise split end caps having first and second halves to assist in releasing the soil sample from the enclosure.

9. The apparatus of claim 1 in combination with a laboratory test cell.

10. The apparatus of claim 9 wherein the laboratory test cell comprises a tri-axial permeability cell.

11. The apparatus of claim 1 wherein the pressure introduced through the permeable material comprises water, air or gas pressure.

12. The apparatus of claim 1 wherein the expansive soil sample is:
a. a swelling soil;
b. an expansive clay; or
c. a smectite clay.

13. The apparatus of claim 12 wherein the permeable material resists bulging of the soil sample resulting from swelling.

14. An apparatus for measuring soil permeability, consolidation and swelling characteristics in an expansive or non-expansive soil sample comprising:
a. an enclosure adapted to house the soil sample for acquiring soil permeability results;
b. the enclosure having a rigid wall comprising a permeable portion to assist in introducing pressure into the enclosure; and
c. a flexible membrane within the enclosure acted on by pressure introduced into the enclosure to apply confining or constraining pressure on the soil sample.

15. The apparatus of claim 14 wherein the permeable portion comprises a rigid porous stone cylinder.

16. The apparatus of claim 15 wherein the rigid porous stone cylinder comprises a split cylinder having first and second halves to assist in releasing the soil sample from the rigid porous stone cylinders.

17. The apparatus of claim 16 wherein the top and bottom end caps comprise split end caps having first and second halves to assist in disassembling the apparatus.

18. The apparatus of claim 14 in combination with a laboratory test cell.

19. The apparatus of claim 18 wherein the laboratory test cell comprises a tri-axial permeability cell.

20. An apparatus for measuring soil permeability, consolidation and swelling characteristics in an expansive or non-expansive soil sample comprising:
a. an enclosure adapted to house the soil sample for acquiring soil permeability results;
b. the enclosure having a rigid wall comprising a porous stone cylinder to assist in introducing pressure into the enclosure; and
c. a flexible membrane within the enclosure acted on by pressure introduced into the enclosure to apply confining or constraining pressure on the soil sample.

21. The apparatus of claim 21 wherein the porous stone has a cross-section is:
a. a circular cross-section;
b. a square cross-section;
c. a rectangular cross-section; or
d. a polygonal cross-section.
